(19) United States
(12) Patent Application Publication
(10) Pub. No.: US 2026/0221161 A1
(43) Pub. Date: Jul. 30, 2026

(54) USER ADAPTIVE VIDEO STITCHING

(71) Applicant: International Business Machines Corporation, Armonk, NY (US)

(72) Inventors: Sarbajit Kumar RAKSHIT, Kolkata (IN); Sathya SANTHAR, Ramapuram (IN); Sridevi KANNAN, Chennai (IN); Samuel Mathew JAWAHARLAL, Chennai (IN)

(21) Appl. No.: 19/041,623

(22) Filed: Jan. 30, 2025

(51) Int. Cl. G11B 27/036; G06F 16/732; G06F 40/279; G06V 10/40; G06V 10/74; G11B 27/10

(52) U.S. Cl. CPC G11B 27/036; G06F 16/732; G06F 40/279; G06V 10/40; G06V 10/74; G11B 27/10

(57) ABSTRACT

Methods, computer program products, and systems are presented. The method computer program products, and systems can include, for instance: expanding a video search query of a user, wherein there is produced in dependence on the expanding a plurality of text strings defining an ordered list of text strings; applying, for respective ones of text strings of the ordered list of text strings, video search query data to one or more video sharing system; comparing text data provided in dependence on a certain text string of the ordered list of text strings to text based metadata of a certain candidate video file dataset; selecting from the comparing; formatting a composited video file in dependence on the selecting; and outputting the composited video file to the user.

### BACKGROUND

Embodiments herein relate to video processing generally and specifically to user adaptive video stitching.

Video-sharing systems offer a wide array of features to enhance user experience, content accessibility, and creator engagement. They support content upload and management with tools for organizing, editing, and tagging videos for discoverability. High-quality video playback is enabled through adaptive streaming and player controls like captions, speed adjustment, and volume settings. Platforms encourage user interaction through likes, comments, sharing options, and subscriptions, while search and discoverability are enhanced with personalized recommendations, trending videos, and playlists. Platforms cater to diverse audiences with multi-device support, including mobile apps, smart TVs, and web access. Community-building tools, such as live streaming and collaborative features, foster deeper connections between creators and audiences. Accessibility features, like subtitles, audio descriptions, and customizable interfaces, improve inclusivity, while privacy controls and encryption safeguard user data and content.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example:

Methods, computer program products, and systems are presented. The method computer program products, and systems can include, for instance: expanding a video search query of a user, wherein there is produced in dependence on the expanding a plurality of text strings defining an ordered list of text strings; applying, for respective ones of text strings of the ordered list of text strings, video search query data to one or more video sharing system, wherein as a result of the applying there is produced for respective ones of the text strings a candidate video file dataset; comparing text data provided in dependence on a certain text string of the ordered list of text strings to text based metadata of a certain candidate video file dataset associated to the certain text string produced by the applying; selecting from the comparing a video file from the certain candidate video file dataset a matching video file that matches the certain text string; formatting a composited video file in dependence on the selecting, wherein the composited video file includes video data of the matching video file; and outputting the composited video file to the user.

In another aspect, a computer program product can be provided. The computer program product can include a computer readable storage medium readable by one or more processing circuit and storing instructions for execution by one or more processor for performing a method. The method can include, for example: expanding a video search query of a user, wherein there is produced in dependence on the expanding a plurality of text strings defining an ordered list of text strings; applying, for respective ones of text strings of the ordered list of text strings, video search query data to one or more video sharing system, wherein as a result of the applying there is produced for respective ones of the text strings a candidate video file dataset; comparing text data provided in dependence on a certain text string of the ordered list of text strings to text based metadata of a certain candidate video file dataset associated to the certain text string produced by the applying; selecting from the comparing a video file from the certain candidate video file dataset a matching video file that matches the certain text string; formatting a composited video file in dependence on the selecting, wherein the composited video file includes video data of the matching video file; and outputting the composited video file to the user.

In a further aspect, a system can be provided. The system can include, for example, a memory. In addition, the system can include one or more processor in communication with the memory. Further, the system can include program instructions executable by the one or more processor via the memory to perform a method. The method can include, for example: expanding a video search query of a user, wherein there is produced in dependence on the expanding a plurality of text strings defining an ordered list of text strings; applying, for respective ones of text strings of the ordered list of text strings, video search query data to one or more video sharing system, wherein as a result of the applying there is produced for respective ones of the text strings a candidate video file dataset; comparing text data provided in dependence on a certain text string of the ordered list of text strings to text based metadata of a certain candidate video file dataset associated to the certain text string produced by the applying; selecting from the comparing a video file from the certain candidate video file dataset a matching video file that matches the certain text string; formatting a composited video file in dependence on the selecting, wherein the composited video file includes video data of the matching video file; and outputting the composited video file to the user.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 is a system for adapting stitched video including a manager system, user equipment (UE) devices, video sharing systems, and a social media system according to one embodiment;

FIG. 2 is a flowchart depicting a method for performance by a manager system interoperating with UE devices models in a video sharing system and one or more video sharing system according to one embodiment;

FIG. 3 depicts presentment of structured model prompt for prompting a large language model (LLM) according to one embodiment;

FIG. 4 is a schematic diagram depicting performance of a method by a manager system according to one embodiment;

FIG. 5 depicts presentment of a structured model prompt for prompting a generative adversarial network machine learning (GAN) machine learning model according to one embodiment;

FIG. 6 depicts a formatted output video file data structure comprising composited stitched video data according to one embodiment;

FIG. 7 depicts a flowchart of a method for performance of a method according to one embodiment;

FIG. 8 depicts an artificial neural network (ANN) according to one embodiment;

FIG. 9 depicts a computing environment according to one embodiment.

### DETAILED DESCRIPTION

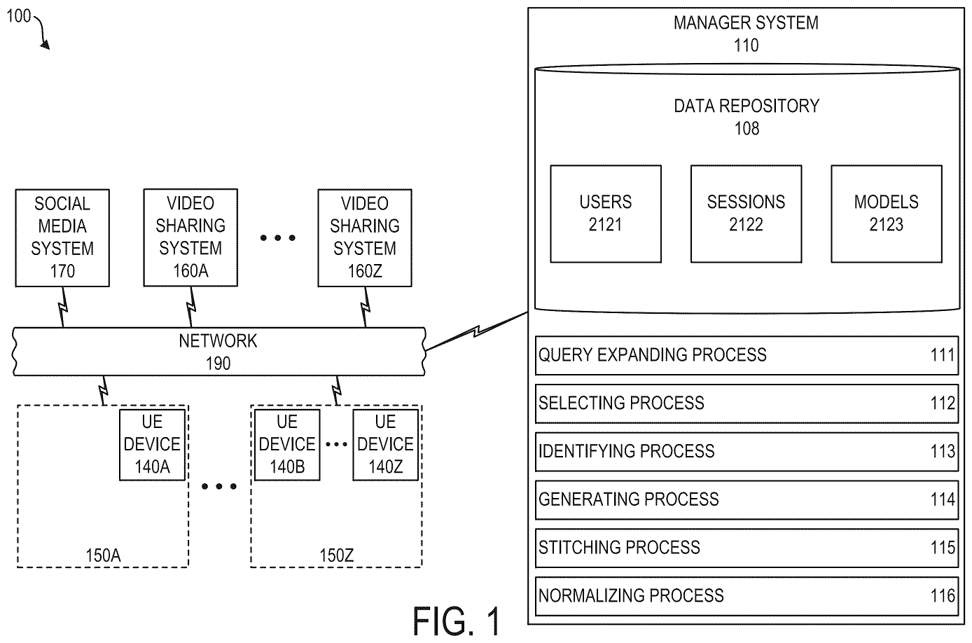

System 100 for performing user adaptive video stitching is set forth in reference to FIG. 1. System 100 can include manager system 110 having an associated data repository 108, user equipment (UE) devices 140A-140Z, video sharing systems 160A-160Z, and social media system 170. Manager system 110, UE devices 140A-140Z, video sharing systems 160A-160Z, and social media system 170 can be computing node based systems in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

In one embodiment, manager system 110 can be external to each of UE devices 140A-140Z, video sharing systems 160A-160Z, and social media system 170. In another embodiment, manager system 110 can be collocated with one or more UE device of UE devices 140A-140Z, video sharing systems 160A-160Z, and social media system 170. UE devices 140A-140Z can be UE devices associated to users of system 100.

Users of system 100 can be users who can define a search query for return of video in relation to the search query. The video can have associated audio data, UE devices can be provided, e.g., by sensor or non-sensor equipped personal computers, laptops, tablets, smart phones, and the like. UE devices 140A-140Z can additionally or alternatively be provided by dedicated sensor apparatus having one or more sensor. Sensors of UE devices 140A-140Z can include, e.g., cameras, Infrared, RF, ultrasound, and optical sensors, XRF, NIR, and terahertz sensors for identifying materials; mass spectrometers, gas sensors, and Raman spectroscopy for detecting chemicals.

Video-sharing systems 160A-160Z can leverage a range of technologies to provide seamless user experiences. Core components include video processing and storage, where uploaded videos are transcoded into multiple resolutions and formats for adaptive streaming using protocols like DASH or HLS. These videos are stored in distributed, scalable cloud storage systems to ensure availability and low-latency delivery worldwide via Content Delivery Networks (CDNs). Frontend systems handle user interfaces, offering features like playlists, recommendations, and commenting. Backend systems manage user data, video metadata, and real-time streaming analytics. Machine learning powers recommendation algorithms, analyzing user behavior, watch history, and video features to suggest personalized content. Search engines of Video-sharing systems 160A-160Z can include information retrieval systems. Videos can be indexed using metadata (titles, descriptions, tags) and processed using natural language processing (NLP) techniques to extract contextual meaning. Deep learning models analyze audio and video content to identify topics, objects, or people, enriching searchability. User signals like watch time, likes, and shares influence ranking algorithms, alongside relevance to the query. Search engines prioritize videos by relevance, quality, and engagement, combining semantic search with algorithms tuned for user preferences. To optimize content discovery, platforms use auto-suggestions, autocomplete, and search filters. Advanced features like speech recognition (captions), image analysis (thumbnails), and community signals (comments) further enhance search accuracy. These technologies operate at scale, handling billions of videos and users by integrating distributed computing, cloud services, and data replication across global infrastructures, ensuring fast, personalized video delivery.

The different UE devices 140A-140Z, which can be associated different users, can be distributed between different geospatial regions 150A-150Z. The different geospatial regions 150A-150Z can be defined, e.g., by venues such as item acquisition venues, residences, office buildings, enterprise facilities, and the like. The different geospatial areas 150A-150Z can alternatively or additionally comprise outdoor venues.

As depicted in FIG. 1, some geospatial regions of geospatial regions 150A-150Z can include one UE device, whereas other geospatial regions of geospatial regions 150A-150Z can include multiple UE devices 150A-150Z. Each user of system 100 can have associated thereto, one or more UE device of UE devices 140A-140Z.

Data repository 108 can store various data. Data repository 108 in users area 2121 can store data on users of system 100. When a user registers with system 100, manager system 110 can assign a universal unique identifier (UUID) to the user and within users area 2121 can store various data associated to the user, e.g., contact information of the user, permissions of the user, address data of UE devices of the user, and the like.

Data repository in sessions area 2122 can store data on sessions that are managed by manager system 110. Sessions managed by manager system 110 can include search query processing sessions in which manager system 110 processes an incoming search query from a certain user and returns stitched video to the certain user. Session data can include, e.g., input query data of a user, expanded query results, context data of a user, returned video data from a video search, and the like.

Data repository 108 in models area 2123 can store various trained models that are trained with use of machine learning. Models stored in models area 2123 can include, e.g., one or more large language model (LLM). Models area 2123 can also include one or more generative adversarial network model (GAN). Models of model area 2123 can include, e.g., one or more video GAN configured as a conditional GAN, one or more style-based GAN, and/or one or more LipGAN. LLMs (Large Language Models) rely on transformers, which use self-attention mechanisms for understanding and generating text. They are trained on large datasets for tasks like text generation, translation, and summarization, with models like GPT, BERT, and T5. GANs (Generative Adversarial Networks) use deep learning architectures, primarily Convolutional Neural Networks (CNNs), in a generator-discriminator framework. The generator creates data (e.g., images, videos), while the discriminator classifies it as real or fake. Variants include StyleGANs for controllable image synthesis and Video GANs for temporal generation. Both LLMs and GANs leverage deep learning advancements and task-specific innovations to achieve high performance. Models of model area 2123 can include one or more YOLO model that can employ deep learning, primarily Convolutional Neural Networks (CNNs), for real-time object detection, integrating features like multi-scale predictions, anchor boxes, and loss functions for classification and localization. Models of models area 2123 can include one or more NLP model which can leverage techniques like Hidden Markov Models and Naïve Bayes, as well as deep learning architectures like RNNs, LSTMs, and transformers.

Manager system 110 can run various processes. Manager system 110 running query expanding process 111 can include manager system 110 expanding an incoming search query received from a certain user. Manager system 110 performing query expanding process 111 can include manager system 110 presenting a structured prompt to an LLM of models area 2123.

The structured prompt can incorporate text data from an original search query of a user and can attach to this original search query data additional data. The additional data can include request data requesting the LLM to perform a specified output to format a specified output and/or can include context data of the user. Context data of the user can include, e.g., sensor data of a user that characterizes a geospatial environment of the user and/or preferences data of the user.

On response to being presented with structured prompt data, the described LLM can return from the structured prompt a set of text strings. Manager system 110 can present a structured prompt to an LLM so that the LLM returns a set of text strings in an ordered list of text strings.

Manager system 110 running query expanding process 111 can include manager system 110 querying one or more video sharing system of video sharing systems 160A-160Z with text data that includes extracted text from the output set of text strings output from the LLM.

In response to being queried with the text string, the one or more video sharing system 160A-160Z can return a set of candidate video files. Manager system 110 running selecting process 112 can include manager system 110 examining the set of candidate video files for a text string for selecting a video file from the set of candidate video files matching the text string. Manager system 110 running selecting process 112 include manager system 110 performing a clustering analysis for identification of a video file having a threshold degree of similarity to an input text string. Manager system 110 running selecting process 112 can record selected video files within session area 2122.

Manager system 110 running identifying process 113 can include manager system 110 identifying gaps in a returned sequence text strings. A gap in a set of text strings where manager system 110 is unable to discover a video file from an output set of candidate video files that matches the text string. Manager system 110 running identifying process 113 can record gaps within session area 2122.

Manager system 110 running generating process 114 can include manager system 110 generating video data for each identified gap identified by manager system 110 running identifying process 113. Manager system 110 running generating process 114 can additionally or alternatively include manager system 110 generating transition video for stitching between video segments of video files selected by selecting process 112 and/or video segments generated by generating process 114 for gaps filling.

Manager system 110 running stitching process 115 can include manager system 110 formatting and producing a video file that comprises in an ordered sequence all video segments selected by selecting process 112 and generated by generating process 114. The ordered sequence can map to the order of the output text strings output by manager system 110 running query expanding process 111.

Manager system 110 running a normalizing process 116 can include manager system 110 normalizing stitched video segments stitched by stitching process 115. Manager system 110 running a normalizing process can include manager system 110 replacing audio data of one or more video segments with replacement audio so that multiple video segments have matching audio. Manager system 110 running a normalizing process can include additionally or alternatively configuring a video segment so that video lip movement is synchronized to associated audio associated of the video segment.

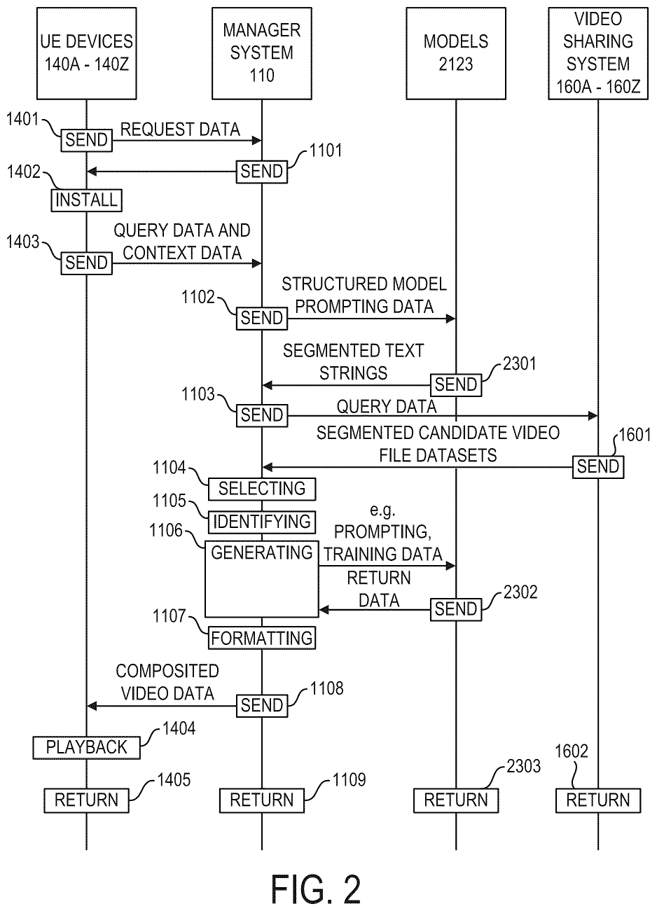

A method for performance by manager system 110 interoperating with UE devices 140A-140Z, models of models area 2123, and video sharing systems 160A-160Z as set forth in reference to the flowchart of FIG. 2.

At send block 1401, UE devices of UE devices 140A-140Z associated to a certain user can be sending request data for manager system 110 at send block 1401. The request data can include request data requesting registration of a user with manager system 110. There can be sent at block 1401, e.g., preferences data of the certain user as well as context data of the user. There can also be sent with the request data sent at block 1401 contact data of the user, e.g., email and/or social media addresses of the user and UE device addresses the various UE devices associated with certain user.

On receipt of the request data sent at block 1401, manager system 110 can store the received user data into users area 2121 and can proceed to send block for 1101. At send block 1101, manager system 110 can send an installation package to the sending one or more UE device of UE devices. On receipt of the installation package sent at send block 1101, the receiving UE device associated to the certain user can install the installation package at install block 1402. The installation package when installed can configure the receiving UE device to operate in system 100. The installation package sent at send block 1101 can include, e.g., libraries and binary code.

On completion of install block 1402, the certain UE device associated with the certain user can send at send block 1403 query data and context data for receipt by manager system 110. The query data sent at block 1403 can be defined by a search query input by the certain user into a user interface.

Context data sent with the query data can include context data of the user. Context data of the user can include, e.g., preferences, e.g., text based data, specifying preferences of the user, text based data specifying characteristics, text based data specifying characteristics of a geospatial environment of the user. Context data sent at block 1403 can include sensor output data of a sensor for sensing a characteristic of an environment of a user. Sensors of UE devices 140A-140Z can include, e.g., cameras, Infrared, RF, ultrasound, and optical sensors, XRF, NIR, and terahertz sensors for identifying materials; mass spectrometers, gas sensors, and Raman spectroscopy for detecting chemicals.

In addition to the certain UE device sending context data to manager system 110 at block 1403, social media system 170, based on permissions of a user, can also be sending context, data, e.g., text based data specifying preferences of the user. In one embodiment, the text based data can include posts data of the user.

On receipt of the query data and context data sent at send block 1403, manager system 110 can store the context data into users area 2121 and into sessions area 2122 and can proceed to send block 1102. On storage of context data into data repository 108, manager system 110 can in some instances transform the context data into a different form. In one example, manager system 110 can transform sensor output context data into text based data specifying an object or a material. In one example, manager system 110 can transform text based posts data of a social media system 170 into a preference.

In one embodiment, manager system 110 can employ a YOLO object detector for transforming camera image data into a detected object. The YOLO object detector can employ convolutional neural networks to provide real-time object detection. The YOLO object detector can detects available objects and/or materials around the user and can internally map the environment objects to similar objects in the search engine's original video. A YOLO (You Only Look Once) detector identifies objects in a camera image by processing the image in a single neural network pass, making it fast and efficient. The image is resized to a fixed dimension and divided into an S×S grid. Each grid cell predicts a fixed number of bounding boxes and is responsible for detecting objects whose centers fall within it. For each bounding box, YOLO predicts coordinates (x, y, width, height), a confidence score indicating the presence and accuracy of the object, and class probabilities (e.g., “person,” “car”). A convolutional neural network extracts spatial features, encoding object-related information into a feature map. Multiple overlapping bounding boxes are filtered using non-maximum suppression (NMS), retaining the box with the highest confidence score for each object. This results in final bounding boxes with class labels and confidence scores. YOLO's single forward pass approach processes the entire image at once, making it suitable for real-time applications. It balances speed and accuracy, handling diverse object categories by considering the global context of the image. Common uses include autonomous vehicles, surveillance, and robotics, where real-time detection is critical. YOLO's efficiency stems from its grid-based approach and optimized bounding box predictions.

Ultrasound sensor among other sessors can be used for materials detection. Ultrasound sensors can detect ceramics by emitting high-frequency sound waves and analyzing their reflection, transmission, or absorption through materials. Ceramics have unique acoustic impedance and density, causing distinct patterns in the reflected waves compared to other materials like metals, plastics, or wood. The sensor captures these differences, and the data is processed to identify ceramics accurately. Besides ceramics, ultrasound sensors can detect other materials like metals (reflecting most waves due to high density), plastics (low acoustic impedance), glass (similar impedance to ceramics), and composites (varying impedance based on material structure). They are also effective for detecting voids, cracks, or thickness in materials, making them valuable for non-destructive testing in industrial applications, such as sorting, quality control, or structural integrity analysis in mixed-material environments.

Manager system 110 on receipt and storage of the context data sent at send block 1403 can transform posts context data into preference context data of the user using natural language processing. Transforming a text string into a topic mapping and associating it with preferences using NLP involves several steps. First, preprocess the text through cleaning, tokenization, stopword removal, and lemmatization. Then, extract topics using techniques like Named Entity Recognition (NER), keyword extraction (e.g., TF-IDF), or topic modeling methods like LDA or BERTopic. Contextual embeddings from transformers (e.g., BERT) can identify semantic relationships between topics. Map extracted topics to predefined preferences (e.g., “football”-> “sports”) using clustering or a prebuilt mapping. Sentiment analysis further refines preferences by analyzing tone (e.g., positive or negative). Reinforcement through additional context (e.g., user history) can improve accuracy. For example, “I enjoy football and AI” maps “football” to “sports” and “AI” to “technology,” both with positive sentiment. Tools like SpaCy, Hugging Face, and Gensim support these processes, enabling automated topic extraction and mapping to preferences for applications like recommendation systems or user profiling.

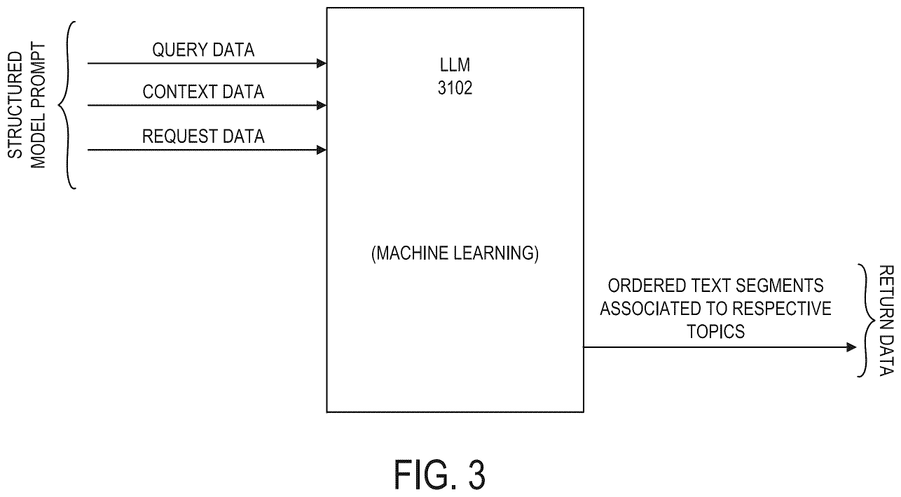

At send block 1102, manager system 110 can send structured model prompting data to an LLM of models area 2123. Manager system 110 presenting a structured prompt at send block 1102 is depicted in FIG. 3. The structured prompting data sent at send block 1102 can include query data and context data sent at block 1403, as well as request data that specifies a particular output by the LLM.

At send block 1102, manager system 110 can send to an LLM of models area 2123 a structured prompt. Referring to FIG. 3, manager system 110 can send a structured prompt to LLM 3102, wherein the structured prompt includes (a) query data sent at send block 1403, (b) context data (also sent at block 1403) and (c) request data. The request data can include text based data that specifies that LLM 3102 should format a return response defining an ordered list of text strings.

Based on query data of a user received responsively to send block 1403, manager system 110 can prepare a structured model prompt as set forth in Table A, wherein an original user query is the query “how do you drill a hole in tile,” where the user has a preference for antique goods and saving costs, where the user is working in a bathroom, with a power drill and is working with ceramic tile.

TABLE A
Please expand the following video search query of a user: [ ]
Please tailor your response to the following preferences of the user: [ ]
Please tailor your response to the following environmental conditions of
the user: [ ]
Please return an ordered list of items.

As shown in Table A, manager system 110 can include various template text (indicated in italics) in the structured model prompt including template text defining request data requesting a certain format of return data, and template text prefacing variable text, including context data of the user. In the described example of Table A, manager system 110 can input the user's original input query into the first line of the structured model prompt, can input text based context data specifying preferences of the user in the second line, and can input text based context data specifying environmental conditions of the user in the third line of the structured prompt of Table A. In the described example, manager system 110 can input as preference context data that the user prefers antiques. In the described example, manager system 110 can input as environmental condition context data that the user is working with ceramic tile and has access to a power drill.

In response to being prompted with a structured model prompt is shown in Table A, manager system 110, in one example, can produce a return segmented text as shown in Table B.

TABLE B
How to Drill a Hole in Ceramic Tile

1. Gather Tools and Prepare the Area
Collect the necessary tools: a power drill, tile-specific drill bit (carbide-tipped for affordability or
diamond-tipped for delicate antique tiles), masking or painter's tape, a spray bottle of water, and safety
goggles for eye protection.
Thoroughly clean the tile with a damp cloth to remove any dust or grease, ensuring the drill doesn't
slip.
Place a piece of masking tape over the area where you want to drill. The tape provides traction for the
drill bit and reduces the risk of slipping.
Mark the exact drilling point on the tape with a pencil or marker for precision.
2. Use the Correct Drill Bit and Start Drilling
Choose the appropriate drill bit: a carbide-tipped bit for standard ceramic tiles or a diamond-tipped bit
for antique or delicate tiles to minimize cracking or chipping.
Attach the drill bit securely to the power drill and set the drill to low speed for better control and to
reduce the risk of overheating.
Hold the drill perpendicular (90 degrees) to the tile and apply light, steady pressure. Allow the drill bit
to gradually penetrate the tile without forcing it. Sudden movements or excessive pressure can crack
the tile.
3. Keep the Drill Bit Cool
Ceramic tiles generate heat during drilling, which can cause cracks. Use a spray bottle to continuously
cool the drill bit and the tile.
Alternatively, pause drilling every few seconds to pour a small amount of water over the drilling area.
This prevents overheating and extends the life of the drill bit.
Resume drilling slowly, ensuring the bit remains cool and you maintain steady progress.
4. Clean Up and Secure Fixtures
After the hole is complete, wipe away any dust or debris with a damp cloth or vacuum. Remove the
masking tape gently to avoid chipping the edges of the hole.
Inspect the hole for rough edges or cracks. If necessary, smooth the edges using fine-grit sandpaper.
Install your fixture or fitting using appropriate anchors or screws. For antique aesthetics, consider
vintage-style hardware or repurposed materials to complement the design. Tighten screws carefully to
avoid putting excessive stress on the tile.
By consolidating steps and expanding details, these instructions guide you to achieve a precise, clean
hole in ceramic tile while maintaining cost efficiency and antique aesthetics.

The segmented response data as shown in Table B can be defined by an ordered list of segmented text strings, each text string associated to a different topic of the sequence of topics. Output segmented text strings of Table B can include the respective text strings enumerated under (1) through (4).

In example of Table B, the different topics can be different stages of a process for performance by the certain user. However, the sequence of topics need not reference any stages of process. For example, in another use case a returned set of segmented text strings can map to various topics within topics are at top n list, e.g., top ten vacation list, top ten new compact SUVs, and the like.

On being prompted with the structured model prompt sent at send block 1102, the prompted LLM 3102 can return at send block 2301 segmented text strings, e.g., the segmented text strings specified in Table B, which are headed under respective numerical orders, “1” through “4”.

On receipt of the segmented text strings, manager system 110 can store the text strings into sessions area 2122 and can proceed to send block 1103. At send block 1103, manager system 110 can send text string data provided in dependence on the segmented text strings as video search query data to one or more video sharing system 160A-160Z.

On receipt of the video search query data text string data provided in dependence on various segmented text strings, one or more video sharing system of video sharing systems 160A-160Z at send block 1601 can return segmented candidate video files. The video search query data text string data provided in dependence on the segmented text strings can be extracted verbatim from the text strings and/or can be extracted based on processing of the text strings. To create a shorter semantic representation of a longer text using NLP, manager system 110 can employ summarization techniques. Extractive summarization selects key sentences or phrases from the input text using methods like TF-IDF or TextRank, which score and rank sentences based on importance. Abstractive summarization generates new sentences by paraphrasing the input, leveraging sequence-to-sequence models or transformers like BART, T5, or GPT. Preprocessing steps include cleaning, tokenization, and stopword removal. Semantic understanding can be enhanced through Named Entity Recognition (NER), topic modeling, and dependency parsing.

On receipt of the segmented candidate video files sent at send block 1601, manager system 110 can store the segmented candidate video files sent at block 1601 into sessions area 2122 and can proceed to selecting block 1104.

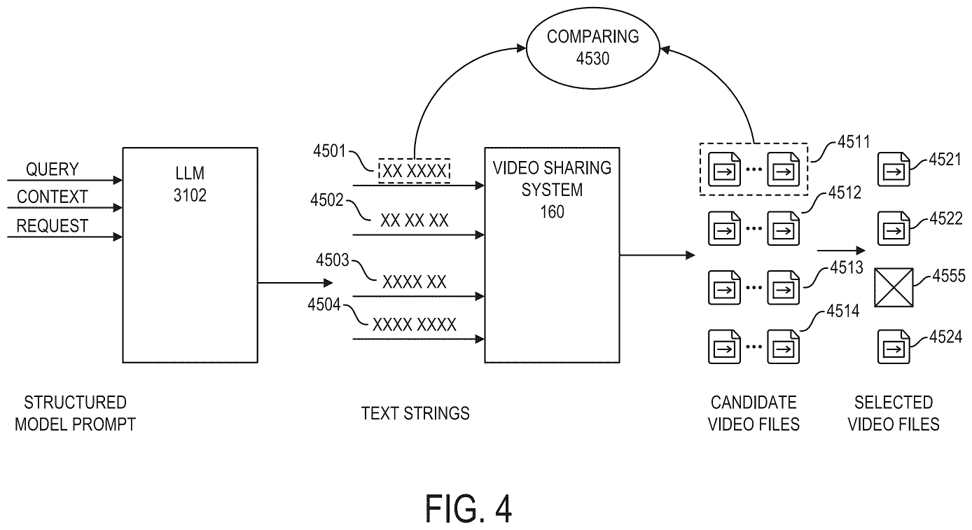

System 100 performing blocks 1403 1102-1103, 2301, and 1601 is described further in reference to the schematic diagram of FIG. 4. Referring to FIG. 4, manager system 110 can present a structured prompt including query data, context data and request data to LLM 3102. LLM 3102 in response can produce multiple different text strings such as the segmented differentiated text strings 4501-4504 defining an ordered list, each mapping to a differentiated topic which topic can define a stage in a process provided by a sequence of actions for the certain user, in one embodiment. In one embodiment, text strings 4501-4504 can be provided by the ordered list of text strings associated to the ranged numerals 1 through 4 of Table B.

Further in reference to FIG. 4, manager system 110 can input video search query data into video sharing system 160 in dependence on the various text strings 4501-4504. In presenting video search query data in dependence on text strings 4501-4504, manager system 110 can append template text, e.g., prefacing the text strings to the text string. In presenting video search query data in dependence on text strings 4501-4504, manager system 110 in some use cases can, e.g., with use of NLP as set forth herein transform the text strings 4501-4504 into alternate form, e.g., into text that expresses a semantic meaning of all or part of an original text string.

In response to receipt of the video search query data including text in dependence on the text strings, video sharing system 160 can output multiple sets of candidate video files, e.g., candidate video files 4511-4514, wherein each candidate video file set is associated to one text string of the output text strings 4501-4504. In reference to FIG. 4, output candidate set of video files 4511 can be associated to output text string 4501. Output candidate video file dataset 4512 is associated to text string 4502, output candidate video file dataset 4513 can be associated to text string 4503, and output candidate video file dataset 4514 can be associated to text string 4504. Referring again to the flowchart of FIG. 2, manager system 110 at selecting block 1104 can perform selecting of one video file from a candidate video file dataset associated to each given text string of the set of text strings. In one embodiment, at selecting block 1104, manager system 110 can select one video file from a candidate video file dataset based on semantic similarity between text metadata of the candidate video file dataset and text of the text string associated to the candidate video file dataset.

For performance of selecting at selecting block 1104, manager system 110 can compare at comparing block 4530 (FIG. 4) text data provided in dependence on a certain text string of the text strings 4501-4504 and video file metadata of each candidate video file defining a candidate video file dataset. The comparing 4530 for performance of selecting at selecting block 1104 can include employing word2vec analysis and clustering analysis for generating a similarity score between a certain text string and each candidate video file that makes up a candidate video file dataset associated to the certain text string. Text data provided in dependence on a certain text string of the text strings 4501-4504 can include, e.g., text data extracted verbatim from the certain text string, and/or text data produced by transformation of all or part of the certain text string, e.g., with use of NLP to derive a semantic meaning string of text.

To generate similarity scoring values between a first block of text and a second block of text, Word2Vec and clustering analysis can be used effectively to capture semantic relationships and identify shared patterns. Word2Vec can be used to convert words from both blocks of text into high-dimensional vector representations based on their contextual usage in a training corpus. This can be done by either training a Word2Vec model on a domain-specific corpus or using a pre-trained Word2Vec model that can be leveraged for general language tasks. Once the model is ready, each block of text can be tokenized into individual words, and stop words can be filtered out to focus on meaningful terms. The Word2Vec model can then be used to retrieve vectors for each of these words, which can be aggregated to represent the overall semantic content of each block of text. Common aggregation methods can include computing the mean or weighted mean of the word vectors in each block. These aggregated vectors can then be used to compare the two blocks of text using a similarity metric such as cosine similarity, which can quantify how similar the blocks are by measuring the angle between their vector representations. Cosine similarity values can range between −1 and 1, where a value closer to 1 indicates high similarity, and a value closer to −1 indicates significant dissimilarity.

In addition to the direct vector comparison, clustering analysis can be employed to explore and refine word-level relationships in the two text blocks. Clustering can be applied to the individual Word2Vec vectors of the words in both blocks to group them into semantically similar clusters. Techniques such as k-means clustering or hierarchical clustering can be used to organize the word vectors into groups that can reflect dominant semantic themes. By examining the overlap or divergence of clusters between the two blocks of text, one can identify shared and distinct semantic patterns that can contribute to a more detailed similarity score. For example, the density and proximity of overlapping clusters can indicate strong semantic alignment, whereas a lack of shared clusters can signal significant differences in content. These cluster-based insights can be combined with the aggregated vector similarity to produce a more comprehensive similarity score. This process can be used to handle nuances such as polysemy or context-specific word meanings that are captured by Word2Vec and illuminated further through clustering. By combining Word2Vec embeddings and clustering techniques, the analysis can be tailored to achieve an in-depth and meaningful similarity measurement that balances contextual richness and computational efficiency.

In the described scenario, manager system 110 at selecting block 1104 can perform comparing of text string 4501 to text based metadata of each candidate video file of the candidate video files data set 4511. In one embodiment, video file metadata can include preexisting labels, e.g., provided by the content provider. In one embodiment, manager system 110 can enrich any preexisting metadata via processing of video data. In one embodiment, manager system can employ YOLO detector based processing as set forth herein for enriching of video file metadata.

Manager system 110 can perform the comparing 4530 as between each text string the text strings 4502 to 4501-4504 and its associated candidate video file datasets.

In some embodiments, when processing a given candidate video file for generation of a similarity scoring value, manager system 110 can segment the candidate video file into multiple time segments and can output similarities scoring values for each segment. In such an embodiment, manager system 110 can select the highest scoring video segment as the output scoring value for the candidate video file.

At selecting block 1104, manager system 110 can select one video file associated to various ones of output text strings 4501-4504 based on which video file produced the highest similarity scoring value with respect to the input text string. By selecting a certain video file at selecting block 1104 manager system 110 can select a video segment (e.g., the highest scoring video segment under the similarity scoring process) of the video file for inclusion in a formatted composited video file for presentment to a user.

In reference to FIG. 4, manager system 110 can select for association with text string 4501 the selected video file 4521 amongst candidate video file data set 4511 based on selected video file 4521 producing the highest similarity scoring value with respect to text string 4501.

Manager system 110, in the same manner as described with reference to selected video file 4521, can select video file 4522 to be associated to text string 4502 and can select selected video file 4524 to be associated to input text string 4504.

Input text strings 4501-4504 can define a sequence of topics, e.g., sequence a process stages. On completion of selecting block 1104, manager system 110 can proceed to identifying block 1105. Manager system 110 at identifying block 1105 can identify one or more video gaps in a sequence of text strings such as the sequence of text strings 4501-4504.

Manager system 110 can identify a video gap 4555 (FIG. 4) where manager system 110 at selecting block 1104 does not discover for a given text string a video file within a candidate video file dataset for the given text string having a threshold satisfying level of similarity with the given text string based on the generated similarity scoring value described with reference to selecting block 1104.

In the example of FIG. 4, manager system 110 can identify video gap 4555 where manager system 110 fails to discover an appropriate, i.e., based on similarity score, video file associated to input text string 4503. In performing identifying at identifying block 1105, manager system 110 can discover that one or more text string such as text strings 4501 through 4504 is absent in an associated selected video file from a set of candidate video files based on there being discovered no video file having a threshold level of similarity with the input text string. Manager system 110 can thus identify such one or more text string as having a video gap.

On completion of identifying block 1105, manager system 110 can proceed to generating block 1106. At generating block 1106, manager system 110 can generate video data for any text string of segmented text strings 4501-4504 identified as having a video gap 4555 by being absent of an associated selected video file.

For performance of the described generating of video data for text strings that are missing video files, manager system 110 at generating block 1106 can perform generating with use of structured model prompt sent to a GAN machine learning model.

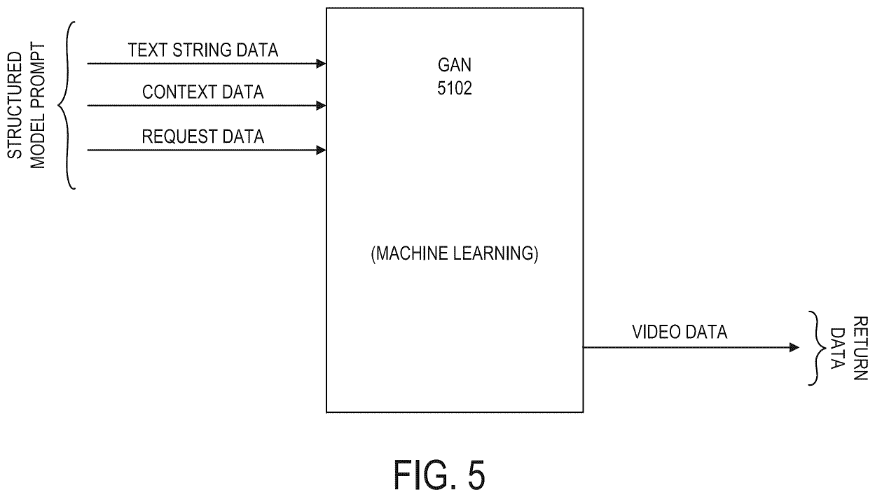

Manager system 110 presenting a structured prompt to a GAN machine learning model as set forth in reference to FIG. 5. At generating block 1106, manager system 110 can send a structured model prompt to a GAN from models area 2123, such as GAN 5102 as set forth in reference to FIG. 5.

The structured prompt for prompting GAN 5102 at generating block 1106 can include (a) text string data provided in dependence the text string associated to the video gap, e.g., gap 4555 identified at identifying block 1105, (b) context data, e.g., context data sent at send block 1403 and/or transformed therefrom and (c) request data which can be provided by text based data that specifies attributes of formatted output video data to be provided by GAN 5102.

In response to being presented with the described structured model prompt, GAN 5102 can output missing video data as set forth in FIG. 5. The missing video data for gap 4555 can define a video segment visually presenting content associated with the input text string data input into GAN 5102 set forth in reference to FIG. 5. Output video data output from GAN 5102 can include associated audio data associated to the video data. The audio data can comprise, e.g., audio narration to accompany a presented video data.

In one embodiment, GAN 5102 can be configured as a pre-trained video GAN and can be further configured as a conditional GAN, cGAN. A pre-trained video GAN offers features like text-to-video synthesis, enabling users to generate videos from textual descriptions by mapping text to latent visual representations. These models ensure temporal consistency, creating smooth transitions across frames, and support object and scene integration, allowing detailed control over objects and their interactions with the environment. Advanced models often provide motion dynamics to simulate realistic behaviors, such as object movement or environmental changes. Additionally, they may support adjustable parameters like video length, resolution, and frame rate. Pre-trained video GANs are optimized for realism, efficiently producing high-quality videos that align with the given prompts. A structured prompt for promoting GAN can include request data specifically requesting GAN 5102 to produce video illustrating actions that are specified in the input text string, e.g., actions such as actions according to “Use a spray bottle to continuously cool the drill bit and the tile.” Prompting data in the described scenario can include prompting data referencing the input context data input to GAN 5102 requesting GAN 5102 to represent an object in a generated video in a manner that matches the appearance of a corresponding object in the user's environment. For example, manager system 110 by the described YOLO detector object detection can extract a set of features, e.g., color, shape, style, for the detected drill in the environment of the user and the model prompting data for prompting GAN 5102 can include request data requesting GAN 5102 to generate a visualization of the drill according to the extracted features, e.g., color shape, style. The described mapping of generated visualizations to actual environmental features can increase a level of engagement of the user to generated video.

At generating block 1106, manager system 110 can also generate transition video data. Transition video data herein refers to video data transitioning between video segments finding an output composited stitched video file as set forth herein. For generating transition video, manager system 110 at generating block 1106 can utilize a style based GAN of models area 2123.

To use a style-based GAN to generate transition videos between video segments, manager system 110 can employ latent space interpolation and frame synthesis. Manager system 110 can encode frames of the two video segments into the GAN's latent space, where each frame is represented as a high-dimensional latent vector. In another aspect, manager system 110 can perform smooth interpolation performed between the latent vectors of the starting and ending frames, creating a gradual transformation. These interpolated vectors can be passed through the GAN generator to produce intermediate frames, which are then assembled into a video sequence. To improve realism, post-processing techniques like motion blur, lighting adjustments, or stylistic blending can be applied, and domain-specific fine-tuning can be performed. As indicated by send block 2302 performance of generating at generating block 1106 can include multiple prompts of various machine learning models.

On completion of generating a generating block 1106, manager system 110 can proceed to formatting block 1107. Manager system 110 for performing stitching at formatting block 1107 can include stitching together video segments from selected video files selected as described in connection with FIG. 4 in block 1104 as well as any generated video segments generated at block 1106. In reference to FIG. 4, selected video files 4521, 4522, and 4524 can define an ordered list of video files. At formatting block 1107, manager system 110 can stitch together in the order of the ordered list described in FIG. 4 video segments from the various video files selected video files 4521, 4522, and 4524. The selected video segments from the various video files need not comprise video data defining an entirety of video data from a given file, but rather in some cases the video file can comprise only a portion of video data from a given video file, i.e., a video segment.

For performing stitching at formatting block 1107, manager system 110 can perform stitching of video segments in the order depicted in FIG. 4 generated video data that has been generated for gap 4555 described in reference to FIG. 4, i.e., can perform stitching in the order of (a) a video segment from selected video file 4521, (b) a video segment from selected video file 4522, (c) a generated video segment for gap 4555, and (d) a generated video segment for video file 4524.

In performing stitching at formatting block 1107, manager system 110 can filter out and discard unused video segments from the various selected video files 4521-4524. Filtered and discarded segments from a given selected video file can include video segments other than the video segment generating the highest similarity score when performing comparing 4530 as described in reference to FIG. 4.

Manager system 110 performing stitching at formatting block 1107, can perform stitching of a chain of video segments from selected video files and generated gap-filling video segments generated as described in connection with generating block 1106.

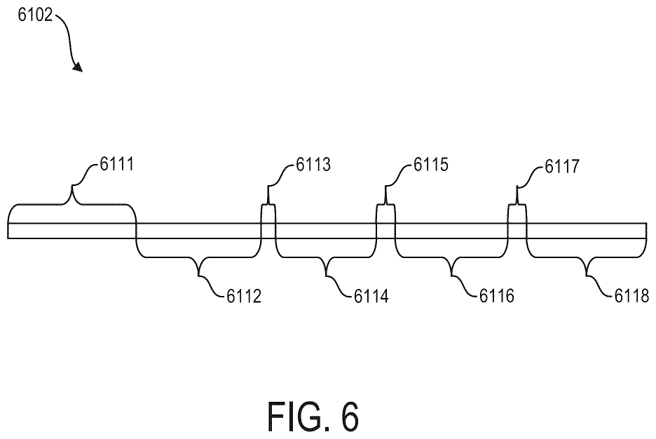

Manager system 110 at formatting block 1107 can perform formatting a video file for transmission, e.g., streaming to a user and playback. An output video data file output at formatting block 1107 is set forth in reference to FIG. 6. Video file 6102 can include a header video segment 6112, video segment 6113, video segment 6114, video segment 6115, and video segment 6117.

Video file header 6111 can include critical metadata that can be used to enable proper decoding, playback, and management. The video header can define the file's format and specify essential properties that determine how the video is processed and displayed. It can include details about the codec used to compress the video, such as H.264, HEVC, or VP9, and the encoding settings, which can dictate the compression efficiency and quality. The resolution can also be specified, including the width and height of the video in pixels, ensuring compatibility with display devices. Aspect ratio information can be included to ensure that the video maintains its intended proportions, regardless of the screen it is played on. Additionally, the frame rate, typically measured in frames per second (fps), can be recorded in the header, which can directly affect the smoothness of playback and the overall viewing experience. For videos with audio, the header can also include information about the audio codec, such as AAC or Opus, along with audio-specific properties like sample rate, bit depth, and channel configuration (e.g., mono, stereo, or surround sound). The header can also store bit rate details, which can indicate the amount of data required per second for playback, helping balance quality and file size. Another important element can be the duration of the video, which specifies the total playback time, providing a straightforward way for players and editing tools to understand the video's length. Information about color profiles, such as HDR or SDR settings, can also be included to ensure accurate color rendering during playback. Beyond these technical specifications, a video header can store additional metadata that can enhance usability and file management. This can include timestamps for the creation and modification of the video, the software or device used for its creation, and even author or copyright information. For videos with additional features, headers can also support subtitle tracks, closed captions, and chapter markers, allowing viewers to navigate or access specific parts of the video more easily. In advanced formats, like MP4 or MKV, the header can accommodate information about multiple video and audio tracks, providing flexibility for multilingual content or alternative versions of the video. The organization of this data can vary depending on the container format, such as MP4, MKV, AVI, or MOV, each of which can define specific structures for storing header information. These headers can also include indexing data, which can allow for efficient seeking and fast-forwarding within the video. By providing such detailed metadata, video headers can be used to optimize playback across a range of devices and ensure compatibility with different media players and software. Additionally, they can facilitate troubleshooting by providing insights into the technical specifications of the video. Whether for simple playback or advanced video editing, the header can be a key element that ensures the video functions as intended while maintaining its quality and integrity.

To format stitched video file 6102 for streaming and playback, manager system 110 can encode it using a widely supported codec like H.264 or H.265 (HEVC) for efficient compression without sacrificing quality. Manager system 110 can employ a container format like MP4 or MKV, ensuring compatibility across devices and platforms. Manager system 110 can segment the video into smaller chunks (e.g., HLS or DASH) for adaptive streaming, allowing dynamic adjustments based on the user's bandwidth. Manager system 110 can add metadata, e.g., header metadata for playback compatibility, such as frame rate and audio sync information. Manager system 110 can send the video to a content delivery network (CDN) for low-latency streaming, ensuring the video loads quickly and plays smoothly for the user, regardless of their device or connection speed.

Output video file 6102 of FIG. 6 defining a data structure can correspond to the particular use case of FIG. 4, where video files are selected for the ordered first and second text strings 4501 and 4502 where there is a generated gap filling video segment for the gap 4555 associated to the third ordered text string 4503, and where there is a selected video file selected for the fourth ordered text string 4504 in the particular use case of FIG. 4.

Referring again to FIG. 6, video segment 6112 can be extracted from selected video file 4521 at FIG. 4 can be defined by video data frames of selected video file 4521. Video segment 6114 can be extracted from video file 4522 and can be defined by video data frames of edit selected video file 4522. Video segment 6116 can be defined by video data frames generated at generating block 1106 for gap 4555 depicted in FIG. 4. Video segment 6118 can be extracted from selected video file 4524 selected for text string 4504 and can be defined by video data frames of selected video file 4524.

In further reference to FIG. 6, video segment 6113 can include transition video frames generated at generating block 1106 for playback between video segment 6112 and video segment 6114. Video segment 6115 can include generated transition video frames generated at generating block 1106 for playback between video segment 6114 and video segment 6116. Video segment 6117 can include generated transition video data frames generated at generating block 1106 for playback between video segment 6116 and video segment 6118.

Regarding the video segments depicted in respective data structure 6102, video file data structure 6102 can be configured so that on playback the various video segments 6112-6118 can be played back in the sequence depicted in FIG. 6, namely the sequence 6112-6118.

In formatting a composited video file in accordance with the data structure 6102 depicted in FIG. 6 at formatting block 1107, manager system 110 can perform normalizing of the composited video file. Normalizing of the composited video file can include normalizing audio data of multiple ones of video segments of the composited video file so that narrator audio data can be presented consistently across the multiple, e.g., all video segments. To replicate the narration voice from one video segment and use it in a second, manager system 110 can perform extracting the audio from the first video with tools like FFmpeg or audio editors. Manager system 110 can isolate the narration to remove background noise or music. Manager system 110 can use a voice cloning tool that can analyze the narrator's voice and create a digital voice model. Once the voice is cloned, manager system 110 can input a text based transcript for the second video into a text-to-speech system that uses the cloned voice. Manager system 110 can synthesize narration that matches the original speaker's tone, pacing, and expression. After generating the narration, manager system 110 can align the audio with the visuals of the second video using video editing software. Adjust the timing to ensure the narration syncs perfectly with the video. Additionally, apply audio enhancements like equalization, noise reduction, or reverb to match the sound profile of the first video for a seamless transition. Embodiments herein recognize that voice cloning can employ deep learning architectures like Tacotron, WaveNet, or HiFi-GAN to analyze the original audio and create a voice profile that replicates the speaker's tone, pitch, and cadence. Speech synthesis models, often based on Transformer architectures, then can use this cloned voice to generate new narration from a provided script. These models are trained on large datasets of human speech to ensure natural and expressive audio output. Additional ML models may be used for post-processing to ensure the synthesized narration matches the acoustic features of the original audio, creating a seamless and realistic result.

In performing normalizing at formatting block 1107, manager system 110 additionally or alternatively can perform lip synchronization so that a narrator's lips are synchronized to voice, which can be synthesized voice as set forth herein. Manager system can employ a LipGAN for performing lip synchronization. In one embodiment, manager system 110 can employ a LipGAN to aligns a speaker's lip movements in a video to match given audio accurately. In one aspect, manager system 110 can prepare various inputs: a video with a visible face and clear audio. Preprocessing can involve detecting the face region using tools like OpenCV and extracting facial landmarks around the lips. Simultaneously, audio can be converted into features such as Mel-spectrograms or phoneme embeddings to represent speech patterns. These inputs can be fed into LipGAN, which uses the audio to predict and modify the lip movements in the video frames, ensuring they match the speech. The modified frames can be reintegrated into the original video while maintaining consistent lighting, skin tones, and smooth transitions. Finally, the adjusted video frames and audio can be merged into a synchronized output using tools like FFmpeg.

On completion of formatting block 1107, manager system 110 can output the generated composited stitched video file having the video file data structure 6102 as set forth in FIG. 6 and can proceed to send block 1108.

At send block 1108, manager system 110 can send the output video data file for playback to the certain UE device and the certain UE device can playback the video data file at playback block 1404.

On completion of send block 1108, manager system 110 can proceed to return block 1109. At return block 1109, manager system 110 can return to a stage preceding block 1101 for receipt of next request data and can iteratively perform the loop of blocks 1101-1109 for a deployment period of manager system 110. It will be understood that manager system 110 can be servicing multiple instances of query data from multiple users concurrently through a deployment period of system 100.

On completion of playback block 1404, UE devices 140A-140Z can proceed to return block 1405. At return block 1405, UE devices 140A-140Z can return to a stage preceding send block 1401 for performance of a next instance of sending request data and UE devices 140A-140Z can iteratively perform the loop of blocks 1401-1405 for a deployment period of UE devices 140A-140Z. It will be understood that in some instances at send block 1101 and install block 1402 system 110 can install updates to an installation package.

On completion of send block 2302, models of models area 2123 can proceed to return block 2303. At return block 2303, the models can return to stage preceding block 2301 and the models can iteratively perform the loop of blocks 2301-2303 for a deployment period of models area 2123.

On completion of send block 1601, video sharing system 160A-160Z can proceed to return block 1602. At return block 1602, video sharing system 160A-160Z can return to stage preceding send block 1601. Video sharing systems 160A-160Z can iteratively perform the loop at block 1601-1602 for a deployment period of video sharing systems 160A-160Z.

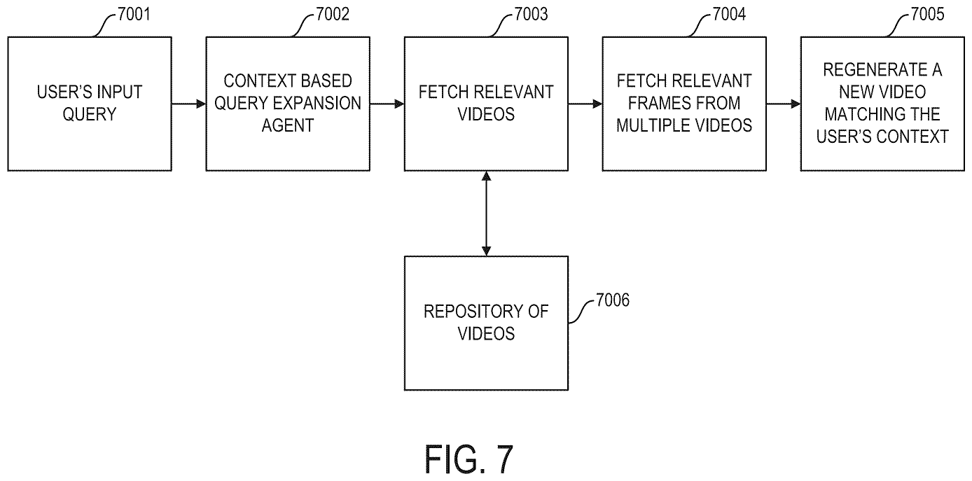

Referring to FIG. 7, system 100 at block 7001 can receive a user's input query. At block 7002, manager system 110 can perform query expansion and can proceed to block 7003. At block 7003 manager system 110 can communicate with a repository 7006 provided by one or more video sharing system of video sharing systems 160A-160Z and can proceed to block 7004. At block 7004, manager system 110 can fetch relevant frames and can proceed to block 7005 to format a composited video file.

Embodiments herein recognize that growth of the Internet has touched upon every sphere of life. Business is no exception to it. Embodiments herein recognize that more and more companies and individuals are bringing their business online. Embodiments herein recognize that nowadays videos are used as a tool to advertise and promote the business. Embodiments herein recognize that enterprises upload relevant videos on promotional sites such as video sharing systems so that people can extract the most relevant video content. Embodiments herein recognize that a majority of information streamed today are in video format. Embodiments herein recognize that presentments to users can benefit from predicting video frames.

Embodiments herein recognize that video understanding is a challenging problem. Embodiments herein recognize that because a video contains spatio-temporal data, its feature representation can include both appearance and motion information. Embodiments herein recognize that appearance and motion information of video can benefit automated understanding of the semantic content of videos, such as web-video classification or sport activity recognition, robot perception and learning. Embodiments herein recognize that just like humans, an input from a robot's camera is seldom a static snapshot of the world, but takes the form of a continuous video.

Embodiments herein recognize that a video search engine can define a web-based search engine which crawls the web for video content. Embodiments herein recognize some video search engines parse externally hosted content while others allow content to be uploaded and hosted on their own servers. Embodiments herein recognize some engines also allow users to search by video format type and by length of the clip. Embodiments herein recognize video search results can be accompanied by a thumbnail view of the video. Embodiments herein recognize that video search engines can be defined by computer programs designed to find videos stored on digital devices, either through Internet servers or in storage units from the same computer. Embodiments herein recognize these searches can be made through audiovisual indexing, which can extract information from audiovisual material and record it as metadata, which can be tracked by search engines.

Embodiments herein recognize that existing video search engines fail to locate the best and most relevant videos for a user. With use of current search engines, a user commonly must manually view low relevancy video data of multiple different video files uncovered from a search in order to manually locate relevant content.

Embodiments herein can provide a video search engine providing relevant results to the user. Embodiments herein can include a video analysis process to extract context data specifying attributes of the user's surroundings, e.g., geospatial environment and can employ machine learning technology including a GAN machine learning model to regenerate the resultant video based on the users' context to produce relevant contextual video.

Embodiments herein can include a video analysis and sensor system. With the user's consent, the video analysis and sensor system, provided, e.g., by a UE device of UE devices 140A-140Z appropriately configured analyses the input user's surroundings with a camera and starts to take in the feed to the object detection network.

Embodiments herein can further include a YOLO object detector. The YOLO object detector can detect the available objects and materials around the user and can internally maps such objects and materials to similar objects and materials in the search engine original video. Embodiments herein can include a DNN with a softmax: A DNN network can be made available to decide whether there is a threshold satisfying amount of information around the user during the described video analysis for the GAN machine learning model to regenerate contextually relevant video. Responsive the determination that there is insufficient information, manager system 110 can present one or more query to the user. Manager system 110 can present one or more query to the user regarding the surroundings and the available objects with the user so that it can provide the user's response as input to the generative model to regenerate the contextually relevant video for the user.

Embodiments herein can generate contextually relevant video. Based on the YOLO object detector, the user response regarding the surrounding available materials and the best available video from the search engine, a conditional GAN module (a generator and a discriminator) can be trained to regenerate a contextually relevant video by replacing some of the materials and objects in the original video with objects and/or materials of the user's environment.

Embodiments herein can generate contextually relevant audio for the video. Based on the best available audio from the search engine suggested video, another conditional GAN module (a generator and a discriminator) can be trained to generate contextually relevant audio by using the same voice as the original but only regenerating the audio part which would match the materials shown in the generated video. Embodiments herein can employ LipGAN technology to generate lip-synced contextual video.

In a use case where a user is searching for video describing process steps using a search engine, embodiments herein can generate the contextually relevant video to the user with the help of composite AI models based on context data of the user, e.g. of surroundings including materials and objects in the environment of the user.

In one example, a user can search for a specific process using a video search engine with the user's web cam “ON.” Embodiments herein can obtain permissions of the user to record the user's surroundings including materials and objects around the user. The video analysis and sensor system can analyze the user's surroundings with the camera and can feed extracted data to the next module (object detection network).

A YOLO object detector can employ convolutional neural networks to provide real-time object detection. The YOLO object detector can detects available objects and/or materials around the user and can internally map the environment objects to similar objects in the search engine's original video.

The objects detected around the user can be passed on to a Deep Neural Network (DNN). A DNN network is made available to decide whether there is enough information around the user during the video analysis so that the GAN machine learning model can generate contextually relevant video for text strings identified as having video gaps at identifying block 1105. The Deep Neural Network can predict whether there are any queries that need to be raised to the user based on his surrounding objects and the available materials.

Where the DNN determines that there is not enough context data in the environment of the user for generation of a contextual video segment for a video gap, manager system 110 can present appropriate one or more query to the user based on the unavailable or partially available information from the user's environment. Where the DNN determines that there is enough context data in the environment of the user for generation of a contextual video segment for a video gap, manager system 110 can generate a video segment for the gap.

Manager system 110 can post queries to the user on the same search engine user interface where a user is prompted to select an option or type a response. Based on the user's response, an AI model can internally search the video search engine and can pick the best available relevant video from the database. The returned video can serve as a reference video for manager system 110 to generate the contextual video content.

Based on a YOLO detector object detection, the user response regarding the surrounding available materials and the best available video from the search engine, a conditional GAN machine learning model (with a generator and a discriminator) can be trained to generate a contextually relevant video segment by replacing some of materials and/or objects in the original video segment with objects and/or materials that are sensed as being in the environment of the user.

Based on satisfactory available audio from the search engine suggested video, another conditional GAN machine learning model (with a generator and a discriminator) can be trained to generate a contextually relevant audio by using the same voice as the original but only generating the audio part which would match the materials shown in the generated video. A conditional generative adversarial network, or cGAN for short, is a type of GAN machine learning model that involves the conditional generation of images by a generator model. Here for first and second cGANs, manager system 110 can provide the best available relevant video in VSE as condition since the regeneration of audio as well as video should follow the reference video.

The generator can take the input of the reference video and audio and can also take in the objects detected around the user based on user response. The generator can be trained on different video regeneration based on the input conditions and the objects. The discriminator can take in the input from the generator as well as the original ones so that it can discriminate between the real and the fake.

A cGAN machine learning model can generate contextual video which is not in sync with text and audio. For achieving lip synchronization, a lipGAN which takes in the audio and the video from the previous stage to generate the lip synced final version of the contextually relevant composited video file for presentment to the user based on user surroundings including available objects and/or materials around the user.

A formatted stitched video file formatted at formatting block 1107 can be contextually relevant to the user with proper lip-sync and audio based on user surroundings including available objects and/or materials around the user which can be detected for generation of geospatial environment context data of the user.

Various available tools, libraries, and/or services can be utilized for implementation of trained machine models herein such as models of models area 2123. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Trained predictive models herein can employ use, e.g., of artificial neural networks (ANNs) support vector machines (SVM), Bayesian networks, and/or other machine learning technologies.

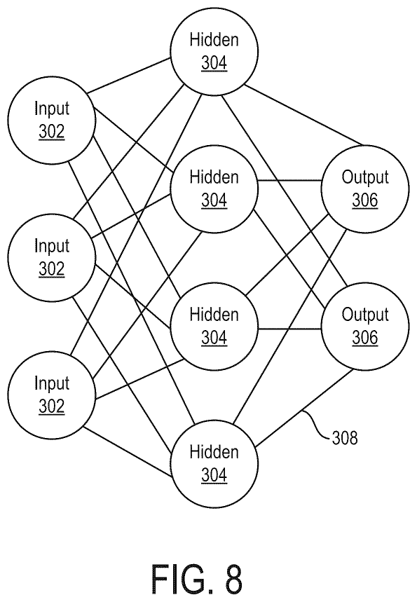

FIG. 8 is an illustration of an example ANN architecture for trained predictive models herein trained by machine learning, such as predictive models stored in models area 2123.

One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN can be configured for a specific application, such as the applications discussed in connection with machine learning models herein.

Referring now to FIG. 8, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Weighted connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output, which can be referring to as outcome training data as referenced in connection with predictive models herein. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process can continue until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, weights of weighted connections 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, weights of weighted connections 308 may be implemented as resistive processing units (RPUs), generating a predictable current output when an input voltage is applied in accordance with a settable resistance.

Certain embodiments herein may offer various technical computing advantages involving computing advantages to address problems arising in the realm of computer systems. Embodiments herein can responsively adapt a formatted composited video file in response to a search query of a user. In one aspect, for expansion of a query a structured prompt and be input into an LLM, wherein the structured prompt can include context data and request data to generate multiple text strings. The multiple text strings can be used to provide query data for into a video sharing system for production of multiple entity video file datasets. Video files can be selected from a candidate video files based on detected similarity to text data provided in dependence on input text strings and generated video segments can be produced from text strings, where video data matching the text string via detected similarity is not identified. A composited stitched video file can be produced for playback that includes both video segments of selected video files and generated video segments that are not extracted from any of its selected video data file. Composited stitched video that is presented to user can adapt responsively to a wide range of user input including text based search query data input of the user, and context data of the user. Context data can include preferences of the user, as well as context data including and/or derived based on sensor output data that specifies characteristics of a geospatial environment of the user. By leveraging data structures to organize relationships, the techniques described herein can increase computing resource efficiency in locating relevant content that can be extracted for presentment to interfaces described herein. Embodiments herein can interactively and adaptively present stitched composited video to user including by expanding a search query of the user with use of an LLM generating missing and transitional video data selecting video files based on expanded text strings resulting from the expansion. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

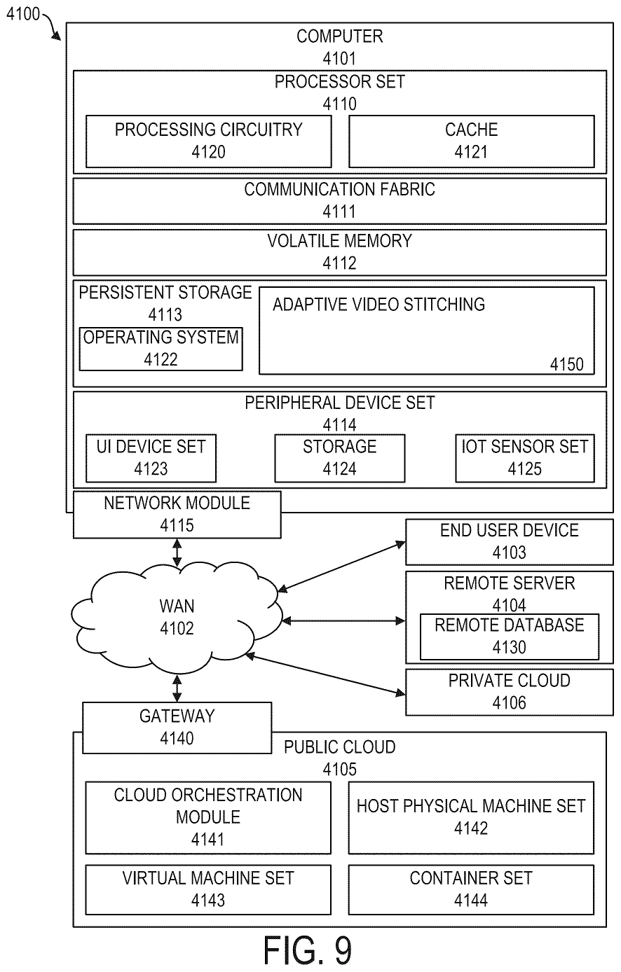

In reference to FIG. 9 there is set forth a description of a computing environment 4100 that can include one or more computer 4101. In one example, a computing node as set forth herein can be provided in accordance with computer 4101 as set forth in FIG. 9.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 9. In one aspect, a computing environment 4100 contains an example of an environment for the execution of at least some of the computer code involved in performing the inventive methods, such as code 4150 for performing processing for adaptive video stitching described with reference to FIGS. 1-8. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IOT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about,” whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
expanding a video search query of a user, wherein there is produced in dependence on the expanding a plurality of text strings defining an ordered list of text strings;
applying, for respective ones of text strings of the ordered list of text strings, video search query data to one or more video sharing system, wherein as a result of the applying there is produced for respective ones of the text strings a candidate video file dataset;
comparing text data provided in dependence on a certain text string of the ordered list of text strings to text based metadata of a certain candidate video file dataset associated to the certain text string produced by the applying;
selecting from the comparing a video file from the certain candidate video file dataset a matching video file that matches the certain text string;
formatting a composited video file in dependence on the selecting, wherein the composited video file includes video data of the matching video file; and
outputting the composited video file to the user.

2. The computer implemented method of claim 1, wherein the method includes performing a comparison of text data provided in dependence on a particular text string of the ordered list of text strings to text based metadata of a particular candidate video file dataset associated to the particular text string produced by the applying and identifying from the performing a comparison that a matching video file matching the particular text string is absent from the particular candidate video file dataset.

3. The computer implemented method of claim 1, wherein the method includes performing a comparison of text data provided in dependence on a particular text string of the ordered list of text strings to text based metadata of a particular candidate video file dataset associated to the particular text string produced by the applying and identifying from the performing a comparison that a matching video file matching the particular text string is absent from the particular candidate video file dataset, and generating responsively to identifying video segment for presentment of content determined in dependence on the particular text string.

4. The computer implemented method of claim 1, wherein the method includes performing a comparison of text data provided in dependence on a particular text string of the ordered list of text strings to text based metadata of a particular candidate video file dataset associated to the particular text string produced by the applying and identifying from the performing a comparison that a matching video file matching the particular text string is absent from the particular candidate video file dataset, and generating responsively to the identifying a video segment for presentment of content determined in dependence on the particular text string, wherein the formatting includes formatting the composited video file so that the composited video file includes video data of the video segment.

5. The computer implemented method of claim 1, wherein the method includes performing a comparison of text data provided in dependence on a particular text string of the ordered list of text strings to text based metadata of a particular candidate video file dataset associated to the particular text string produced by the applying and identifying from the performing a comparison that a matching video file matching the particular text string is absent from the particular candidate video file dataset, and generating responsively to the identifying a video segment for presentment of content determined in dependence on the particular text string, wherein the formatting includes formatting the composited video file so that the composited video file includes video data of the video segment, wherein the generating includes using a generative adversarial network machine learning model.

6. The computer implemented method of claim 1, wherein the method includes detecting an object in an environment of the user, wherein the method includes performing a comparison of text data provided in dependence on a particular text string of the ordered list of text strings to text based metadata of a particular candidate video file dataset associated to the particular text string produced by the applying and identifying from the performing a comparison that a matching video file matching the particular text string is absent from the particular candidate video file dataset, and generating responsively to the identifying a video segment for presentment of content determined in dependence on the particular text string, wherein the formatting includes formatting the composited video file so that the composited video file includes video data of the video segment, wherein the generating includes presenting a structured prompt to a generative adversarial network machine learning model, and wherein prompting data of the structured prompt is determined in dependence on the detecting.

7. The computer implemented method of claim 1, wherein the method includes detecting an object in an environment of the user and extracting features of the object, wherein the method includes performing a comparison of text data provided in dependence on a particular text string of the ordered list of text strings to text based of a particular candidate video file dataset associated to the particular text string produced by the applying and identifying from the performing a comparison that a matching video file matching the particular text string is absent from the particular candidate video file dataset, and generating responsively to the identifying a video segment for presentment of content determined in dependence on the particular text string, wherein the formatting includes formatting the composited video file so that the composited video file includes video data of the video segment, wherein the generating includes presenting a structured prompt to a generative adversarial network machine learning model, and wherein prompting data of the structured prompt is determined in dependence on the detecting and the extracting so that a color and shape of the object as represented in the video segment matches a color and shape of the object in the environment of the user.

8. The computer implemented method of claim 1, wherein the method includes detecting an object in an environment of the user and extracting features of the object, wherein the method includes performing a comparison of text data provided in dependence on a particular text string of the ordered list of text strings to text based metadata of a particular candidate video file dataset associated to the particular text string produced by the applying and identifying from the performing a comparison that a matching video file matching the particular text string is absent from the particular candidate video file dataset, and generating responsively to the identifying a video segment for presentment of content determined in dependence on the particular text string, wherein the formatting includes formatting the composited video file so that the composited video file includes video data of the video segment, wherein the generating includes presenting a structured prompt to a generative adversarial network machine learning model, and wherein prompting data of the structured prompt is determined in dependence on the detecting and the extracting so that a color and shape of the object as represented in the video segment matches a color and shape of the object in the environment of the user, and wherein the formatting includes normalizing the composited video file, wherein the normalizing includes cloning a narrator voice of a first video segment of the composited video file, and synthesizing voice for a second video segment of the composited video file using a cloned voice in accordance with the cloning.

9. The computer implemented method of claim 1, wherein the method includes detecting an object in an environment of the user and extracting features of the object, wherein the method includes performing a comparison of text data provided in dependence on a particular text string of the ordered list of text strings to text based metadata of a particular candidate video file dataset associated to the particular text string produced by the applying and identifying from the performing a comparison that a matching video file matching the particular text string is absent from the particular candidate video file dataset, and generating responsively to the identifying a video segment for presentment of content determined in dependence on the particular text string, wherein the formatting includes formatting the composited video file so that the composited video file includes video data of the video segment, wherein the generating includes presenting a structured prompt to a generative adversarial network machine learning model, and wherein prompting data of the structured prompt is determined in dependence on the detecting and the extracting so that a color and shape of the object as represented in the video segment matches a color and shape of the object in the environment of the user, and wherein the formatting includes normalizing the composited video file, wherein the normalizing includes cloning a narrator voice of a first video segment of the composited video file, and synthesizing voice for a second video segment of the composited video file using a cloned voice in accordance with the cloning, and wherein the normalizing includes synchronizing lip movement of the second video segment to match synthesized voice of the second video segment produced by the synchronizing.

10. The computer implemented method of claim 1, wherein the expanding includes presenting a structured model prompt to a large language model.

11. The computer implemented method of claim 1, wherein the expanding includes presenting a structured model prompt to a large language model, wherein the presenting includes configuring the structured model prompt so that the structed model prompt includes text data of the video search query of the user.

12. The computer implemented method of claim 1, wherein the expanding includes presenting a structured model prompt to a large language model, wherein the presenting includes configuring the structured model prompt so that the structed model prompt includes text data of the video search query of the user, and context data of the user.

13. The computer implemented method of claim 1, wherein the expanding includes presenting a structured model prompt to a large language model, wherein the presenting includes configuring the structured model prompt so that the structed model prompt includes text data of the video search query of the user, context data of the user, and request data requesting that the language model return a response in the form of an ordered list of text strings.

14. A system comprising:
a memory;
at least one processor in communication with the memory; and
program instructions executable by one or more processor via the memory to perform operations comprising:
expanding a video search query of a user, wherein there is produced in dependence on the expanding a plurality of text strings defining an ordered list of text strings;
applying, for respective ones of text strings of the ordered list of text strings, video search query data to one or more video sharing system, wherein as a result of the applying there is produced for respective ones of the text strings a candidate video file dataset;
comparing text data provided in dependence on a certain text string of the ordered list of text strings to text based metadata of a certain candidate video file dataset associated to the certain text string produced by the applying;
selecting from the comparing a video file from the certain candidate video file dataset a matching video file that matches the certain text string;
formatting a composited video file in dependence on the selecting, wherein the composited video file includes video data of the matching video file; and
outputting the composited video file to the user.

15. The system of claim 14, wherein the expanding includes presenting a structured model prompt to a large language model.

16. The system of claim 14, wherein the expanding includes presenting a structured model prompt to a large language model, wherein the presenting includes configuring the structured model prompt so that the structed model prompt includes text data of the video search query of the user.

17. The system of claim 14, wherein the expanding includes presenting a structured model prompt to a large language model, wherein the presenting includes configuring the structured model prompt so that the structed model prompt includes text data of the video search query of the user, and context data of the user.

18. The system of claim 14, wherein the expanding includes presenting a structured model prompt to a large language model, wherein the presenting includes configuring the structured model prompt so that the structed model prompt includes text data of the video search query of the user, context data of the user, and request data requesting that the language model return a response in the form of an ordered list of text strings.

19. The system of claim 14, wherein the operations include performing a comparison of text data provided in dependence on a particular text string of the ordered list of text strings to text based metadata of a particular candidate video file dataset associated to the particular text string produced by the applying and identifying from the performing a comparison that a matching video file matching the particular text string is absent from the particular candidate video file dataset.

20. A computer program product comprising:
a computer readable storage medium readable by one or more processing circuit and storing instructions for execution by one or more processor for performing operations comprising:
expanding a video search query of a user, wherein there is produced in dependence on the expanding a plurality of text strings defining an ordered list of text strings;
applying, for respective ones of text strings of the ordered list of text strings, video search query data to one or more video sharing system, wherein as a result of the applying there is produced for respective ones of the text strings a candidate video file dataset;
comparing text data provided in dependence on a certain text string of the ordered list of text strings to text based metadata of a certain candidate video file dataset associated to the certain text string produced by the applying;
selecting from the comparing a video file from the certain candidate video file dataset a matching video file that matches the certain text string;
formatting a composited video file in dependence on the selecting, wherein the composited video file includes video data of the matching video file; and
outputting the composited video file to the user.
